(19) United States
(12) Patent Application Publication
(10) Pub. No.: US 2007/0118485 A1
(43) Pub. Date: May 24, 2007

(54) Interactive contract service

(76) Inventor: Norbert Gugerbauer, Wien (AT)

Correspondence Address: NORBERT GUERBAUER, OPERNRING 1, WIEN, A-1010, AT

(21) Appl. No.: 11/272,947

(22) Filed: Nov. 15, 2005

(51) Int. Cl. G06Q 99/00; H04L 9/00; H04K 1/00

(52) U.S. Cl. 705/80

(57) ABSTRACT

A method of drafting and searching model contracts on the internet, of holding them available on the internet, of adjusting such contracts to the user's personal needs, of adjusting such contracts to the user's personal needs by intercommunication with a legal counsel or contract party in an interactive “conference room” on the internet, of closing a contract by electronic signature, of payment and transmission of the user fee, and of providing a cross-border service.

### BACKGROUND OF THE INVENTION

An individual interested in placing a contract has to contact a legal counsel to have such contract set up. A variety of forms how those contracts are drafted are available for numerous transactions. In many cases standardized model contracts, which are consistent with the particular transaction, are used. To avoid frequenting a law office, such model contracts are made available through the internet by the present invention. Unlike mere samples, such contracts can so be adjusted to the client's personal needs.

According to present experiences, four categories of purchasers of such model contracts can be distinguished:

Internet-related purchasers—individuals who work in the information technology sector or those wvho use products and services of the information technology more intensely than the average purchaser. This group is used to look for new information initially and primarily on the internet. Applicable types of contracts can be: License agreements, hardware leases, domain transfer agreements, maintenance agreements.

Price-conscious purchasers—individuals who have a fear of entering a law or notary public office. Especially for reasons of economy they are looking for alternatives to legal counsels. Applicable types of contracts can be: Lease contracts, sales contracts, loan agreements.

Non-legal counsels—very often tax advisors, accountants, management consultants, architects and similar professionals are confronted with clients' questions, which they first have no answer to. Applicable types of contracts can be: Company agreements, assignments of claims, building contracts, power of attorney.

Legal counsels—finally also lawyers and notaries public refer to external model contracts, when are not within their regular business. Applicable types of contracts can be: Complex and unusual contracts.

A purchaser of a model contract has certain expectations. Interested purchasers are looking for agreements which are exactly fit for a certain situation in their life. Very often the subject matter of such contract will be obvious, e.g. the purchase of a used car, an apartment lease, a loan. The interested purchaser now looks for a model contract which is suitable for the future deal's purpose.

An appropriate model contract has to be flexible on the one hand, thus has to enable the interested purchaser to input not only his personal data (name and address of the contracting parties for instance) to the model text, but also has to provide him with options of different wordings he then, can choose from. On the other hand this interactive model contract must be presented in a way, that an average purchaser can use it. Purchasers of such model contracts are predominantly not lawyers.

On many occasions this way of automated creation and drafting of a contract will be good enough. But there are also situations when the model contracts have to be adjusted to the contracting parties' personal needs in more detail. Very often such model contracts only make up the basis for the following contract negotiations. This invention provides an interactive way to therefore hold a conference with a counsel or contracting party online, without urging the client to come to a real office.

So far, a contracting party had to frequent a law office in order to obtain a contract document which is fit for the underlying transaction or deal. The legal counsel issues an invoice and waits for payment receipt. Another way is to buy a compilation book of model contracts, which have no individualisation to the purchasers needs at all though. The “interactive contract service” provides for an innovative way of paying fees and royalties to the authors of such contracts and for legal advise.

Legal service is bound to the locations of attorneys, notaries public and tax advisors. If somebody looks for cross-border legal advise, he will contact lawyers near his own location. Those lawyers subsequently engage foreign counsels who are experienced in their jurisdiction, to advise the client thoroughly. This happens especially in the case of cross-border transactions and agreements. Altogether, this is an extensive and costly way to provide the client with a suitable contract. This is disburdened by the “interactive contract service”.

### SUMMARY OF THE INVENTION

A contract service is provided on an internet website by use of a software. The person who carries out such service is the “service provider”. The service can be classified into four modules.

Module 1 enables a contract lawyer to draft interactive model contracts online (through the World Wide Web) and by use of the underlying software, and to hold them ready on the internet website. This drafter is the “contract author”. The correct naming of the contracting parties, correct grammar as well as the correct salutation is provided throughout the contract by this application.

Module 2 offers to choose from the variety of inputted model contracts by interested website users. The application provides for the possibility to amend the chosen model contract by putting in personal data (e.g. parties' names, addresses, price, square meters) as well as to choose from several ways of wording in the contract.

Within the scope of module 3, the purchaser of a model contract can discuss such contract with a future contracting party or a legal counsel online. The website provides a tool, the “conference room” by that parts of the model contract can be changed according to the user's consent. Changes are viewable on both the user's and the opponent's screen. Additionally, a discussion can take place in writing by chat within that “conference room”, or the discussion can be held orally via VoIP (“Voice over Internet Protocol”, internet telephony) or other means of comniunication.

Module 4 provides for an application on the website, by that the contracting parties sign the contract with electronic signature. This application works like the “conference room” application, where both parties meet together.

Drafting and holding-ready of model contracts is free. At the time of the purchase, a user fee (flat fee) in favor of the contract service provider and a royalty in favor of the contract author is due. After the payment transaction the purchaser obtains the document (model contract) for printing out. If a counsel advises a client by use of the “conference room” application, a previously agreed royalty will be due. Like in the case of purchasing a model contract, the billing and transmission of the royalty is proceeded by the contract service provider.

The “interactive contract service” is available to every internet user. Thus, legal consulters and legal counsels from the various jurisdiction can come together, legal service is possible from any location. Cross-border agreements can be drafted, amended and modified directly by specialists from the particular countries and jurisdictions without interposition of locals.

### DETAILED DESCRIPTION OF THE INVENTION

The contract service provider is host of a website. On this website the “interactive contract service” is provided. The in the following described applications are implemented by standard software. The described method is to be applied by using the internet and a standard browser.

Module 1—Drafting and Holding-ready of Model Contracts

First, the application provides for the entry of the category of the future model contract. The contract author also has to enter a heading for the model contract and a numeration for the planned context. The application asks for the number of contracting parties and their “typing identification”. This is an identifying characterization for each party in general legal terms (e.g. “lessor” for person A, “lessee” for person B). The “typing identification” must be entered in singular first. Where plural is necessary in the future model contract, the author has to consider this also. This input of information is a prerequisite for the underlying software to subsequently use and show the correct form of the “typing identification” at every numeration, according to the user's wish.

Second, the application provides for the choice, whether the contracting parties are natural persons or corporations or mixed. By this pre-selection, the contract author also confines the range of the following input of individual data (e.g. a contract between corporations typically needs specific data different from a marriage contract). So the individual data for corporations typically include the names of the board members and the registered office. The contract author can leave the model contract more open, if the contract shall be suitable for both corporations and natural persons. As a next step, the author has to prepare questions to the future user of the model contract, which is to be inputted in the software application. This question later appears to the user, whose answer will be included on the right position of the model contract. Also, the software application asks the author, which typical categories of personal data he wants to include to the model contract (e.g. birth date, registration number, citizenship). The chosen categories later appear in the model contract for subsequent input by the user. This pre-selection application prevents the user from input of unnecessary data for the specific contract. Structure, “typing identification” and individual data questions are subject to change by the author at any time.

Third, as a next step the author can work on each article of the contract, a text field is provided by the application. It allows the input of text by copy/paste as well as direct typing. Also, the author can select the positioning for individual data, i.e. the author chooses a position within the text where he wants the data (e.g. the purchase price) to emerge later in the model contract. For example the user is asked for the amount of the purchase price, so the application provides the entered amount to emerge automatically at the pre-selected position within the model contract.

Fourth, the contract author can decide, how much personal data he wants to have included at different positions of the contract. At one position the author will consider the full range of data necessary (e.g. name, address, birth date, citizenship), at another position within the text just one ore some more data can be sufficient. Alternatively, the “typing identification” (e.g. “the lessee”) can be used.

Fifth, the application provides for the correct word order, article, declension and salutation at the selected position in the subsequent model contract adjusted by the user. The author can choose, whether he wants the name or “typing identification” to emerge at the beginning, in the middle or at the end of a sentence. The application will automatically use the grammatical article starting in upper case or lower case according to the position in the sentence, and will also use the article in the right declension, so that the user obtains a correct model contract. Therefore the author has to make appropriate selections provided by the application. Also, the application sets the correct salutation for the contracting parties, according to the user's choice. Therefore the application makes the user choose a salutation for the specific contracting parties (e.g. “Mr.”, “Ms.”, “Inc.”) and puts it to the right position within the contract text.

Sixth, the application gives the author the opportunity to indicate text components (i.e. words, groups of words or sentences), which then appear to the user as optional. By clicking on such components, the application will include or exclude them in the model contract. This provides the user with the opportunity to totally change the meaning of the contract (e.g. by selecting the optional word “not” or similar in a sentence).

Seventh, the application gives the author the opportunity to enter text components (i.e. words, group of words or sentences), which then appear to the user as an additional option to choose from. This can provide the user with a proposal of various wordings for the same sentence.

Eighth, the author has to enter the amount of royalty he demands for the use of such model contract. The so drafted model contract with its specifications is saved in the contract service provider's database and held ready for demand on the internet.

Module 2—Search for Certain Contracts

Through the displayed method a user can search for the right model contract according to his needs on the website. To obtain the text of the model contract, a link is provided on the contract service provider's website. Model contracts can be searched by category and keywords. The software enables the user to choose from all the inputted models, within a chosen model he can select alternative wording and put in personal data, which later appear on the completed contract. The user can view, modify, amend and finally print out the completed model contract according to the selections, specifications and positionings previously defined by the contract author.

The provided model contracts don't come from anonymous authors but from renowned counsels: Lawyers, notaries public, tax advisors or patent attorneys have the possibility to offer their particular professional knowledge and experience to a broad range of addressees. The user is not bound to the office hours anymore. He is able to obtain the contract even at night and on a holiday. Also, standardized texts can be offered well-priced in comparison to regular legal service fees.

Module 3—Joint Modification in the Conference Room

Additionally, the method also provides for the possibility to discuss and modify the fully completed model contract in a “conference room” on the contract service provider's website. As an advantage, the offered model contracts can be used by different people in different situations. This flexibility can lead to a user's wish to have the contract text checked and approved by a professional. By use of the “conference room” application, this the text can get its professional “final polish”.

Beside of that, a future contract party might wish to participate in the drafting process. The user can also invite this person to the “conference room” for further negotiations. It is much more convenient to discuss a draft in this way with the opportunity to immediately modify the text, than sending drafts to and fro.

The core of this module is the opportunity to modify the underlying contract text while having a dialog with the other party or a counsel. Changes on the draft are viewable immediately afterwards on the screens of the dialog partners. The dialog can proceed by phone, internet telephony (VoIP) or any other regular way outside the “interactive contract service” website. However, the service application provides for a dialog in writing as well. This dialog then appears within the website, including the “conference room”, as a chat room.

To use the “conference room”, the user (“host”) who has adjusted the model contract he chose before can invite anyone else (“guest”) to join the “conference room”. Therefore the user puts in the guest's name, e-mail address and time proposal online provided by the contract service website application. The invitee is free to accept the invitation and comment to the proposed time.

As soon as “host” and “guest” log on to the “conference room”, each side can see the text of the model contract on the screen. Also, an input field is shown. Each user can enter questions, messages, wording proposals which appear to every user. The “host” can choose who shall be in charge of modifying the contract text. He can change this appointment at any time during the dialog. As for the underlying dialog, it is up to the “guest” to decide the form of dialog and the amount of flat royalty for the counseling.

Module 4—Signing the Created Contract by Means of Electronic Signature

Contracts which have been chosen and modified according to the described method can be signed electronically. Standard procedures for electronic signature are used to enable the parties of model contracts to give them binding quality. Such procedures are embodied in the complex contract service system, which works in the same way as the “conference room” application. The contracting parties log on to the system and are free to modify the contract together. Within this application they have the opportunity to provide the agreement with legal effect. Also, such signed contracts can be stored safely on the contract service provider's server for subsequent access.

Payment

Drafting and holding-ready of model contracts shall be free. At the time of the purchase of a model contract, a royalty is due in favor, of the contract author. The contract service provider then charges a user fee (flat fee) as a commission. After the payment transaction the purchaser obtains the document (model contract) for printing out. If a counsel advises a client by use of the “conference room” application, a previously agreed royalty will be due. Like in the case of purchasing a model contract, the billing and transmission of the royalty is proceeded by the contract service provider. The amount of royalty is chosen by the contract author and can be changed at any time. To avoid fraud on the internet, only those users are allowed to obtain the model contracts, who agree to have their bill cashed on a credit card account. Only after proceeding an online inquiry about the credit card authorization, the contract service provider allows access to obtain the model contract.

After receipt of the request to use a model contract, the user is automatically sent a billing statement in the name of the contract author by the contract service provider's software application. The statement is transmitted in the amount of the royalty as file via e-mail. A copy automatically goes to the contract author. Within a time period the contract author is regularly sent a statement by the contract service provider as file via e-mail, showing the number of obtained model contracts in that time period. The remaining amount between user fees and royalties is wired to the contract author's bank account by the contract service provider.

Lawyers and other advisors can offer advice within the range of the “conference room”. The dialog takes place in an internet chat-room within the contract service website, or by other means (e.g. VoIP). As mentioned above, the “guest” decides upon the amount of royalty for counseling. This royalty has to be a flat fee and is determined according to the number of answers, when the dialog is in writing, or according to time, when the dialog is verbal. As far as both “host” and “guest” agree, the number of answers and the number of minutes respectively can be extended for the same amount of royalty again.

To avoid fraud, the billing and charging of the fees is proceeded in the same way as for the purchase of a contract shown above. A flat user fee is billed account of the “host”.

Cross-Border Service

The “interactive contract service” is available to every internet user. Thus, legal consulters and legal counsels from the various jurisdiction can come together, legal service is possible from any location. Until now, legal advise stopped at a jurisdiction's border. Now, cross-border agreements can be drafted, amended and modified directly by specialists from the particular countries and jurisdictions without interposition of locals.

What claimed is:

1. A method for “contract authors” of creating interactive model contracts online by using computerized support, provides by the “contract service provider”, and of holding them ready on the internet (through the World Wide Web), comprising:
(a) Software-supported input of the contract category, the heading of the model contract and the structure of numeration of the contract to be created;
(b) Software-supported input of the number of contracting parties in the model contract;
(c) Software-supported input of a “typing identification” for any contracting party;
(d) Software-supported input, whether the particular contracting party is a natural person or a (corporation;
(e) Software-supported input of additional personal data referring to the contraction parties;
(f) Software-supported input of several articles of the model contract as a text;
(g) Software-supported input of a positioning for individual contract data within the text;
(h) Software-supported input of a positioning for the contracting parties within the text;
(i) Software-supported input of a positioning for the “typing identification”;
(j) Software-supported input of word order, article, declension and salutation for the input of a positioning for the contracting parties within the text;
(k) Software-supported input of an indication of text components, which appear as an option to remove those text components;
(l) Software-supported input of text components, which appear as an alternative option to choose with regard to already existing text components;
(m) Software-supported input of the use fee amount;
(n) Saving the so created model contract in a database and holding it ready for demand on the internet.

2. A method of claim 1, further comprising:
(a) Software-supported search for a model contracts according to contract category and keywords;
(b) Software-supported selection of a model contract;
(c) Software-supported input of the contracting parties' personal data to the model contract;
(d) Software-supported choice of indicated text components, which appear as an option to remove those text components;
(e) Software-supported choice of text components, which appear as an alternative option to choose with regard to already existing text components;
(f) Generating a computer print-out of the so created contract.

3. A method of claim 2, further comprising:
(a) Software-supported input of the user's credit card account information;
(b) Software-supported check-up of the credit card authorization by the provider of the contract service;
(c) Debit entry amounting to the user fee in favor of the “contract author” as well as a flat fee in favor of the “contract service provider”, account of the user's credit card account after successful authorization;
(d) Software-supported release of the created model contract for printing out;
(e) Software-supported creation of an invoice as pdf-file amounting the user fee, and automatic transmission to the “contract author” by e-mail;
(f) Bank transfer of the user fee, held in trust by the “contract service provider”, to the “contract author” by the “contract service provider”.

4. A method of claim 3, further comprising:
(a) Software-supported invitation to a dialog partner (“guest”), who can be chosen freely by the user of the model contract (“host”) by putting the guest's name, his e-mail address as well as a time proposal into the internet application (“invitation”), to hold an interactive “conference”;
(b) Software-supported transmission of the “invitation” to the “guest” via e-mail;
(c) Software-supported, dialog between “host” and “guest” on the internet (“conferencee”), when both log in to the application (“conference room”);
(d) The “host's” software-supported choice during the dialog to determine at any time, whether the “host” or the “guest” is in power to carry out modifications of and amendments to the model contract, which then are apparent on the computer screen immediately;
(e) Generating a computer print-out of the modified or amended contract.

5. A method of claim 4 wherein the dialog is to proceed in writing within a software-supported internet chat-room (“chat”).

6. A method of claim 4 wherein the dialog is to proceed verbally by telephone (including internet telephony—VoIP).

7. A method of claim 5, further comprising:
(a) Software-supported input of a flat amount of royalty for a certain number of answers by the “guest”, whereas an extension of the conference by the same certain number for the same royalty can be agreed;
(b) Software-supported input of the user's credit card account information;
(c) Software-supported check-up of the credit card authorization by the provider of the contract service;
(d) Debit entry amounting to the royalty in favor of the “contract author” as well as a flat fee in favor of the “contract service provider”, account of the user's credit card account after successful authorization;
(e) Software-supported creation of an invoice as file amounting the royalty, and automatic transmission to the “contract author” by e-mail;
(f) Bank transfer of the royalty, held in trust by the “contract service provider”, to the “contract author” by the “contract service provider”.

8. A method of claim 6, further comprising:
(a) Software-supported input of an amount of royalty per minute;
(b) Software-supported input of the user's credit card account information;
(c) Software-supported check-up of the credit card authorization by the provider of the contract service;
(d) Debit entry amounting to the royalty in favor of the “contract author” as well as a flat fee in favor of the “contract service provider”, account of the user's credit card account after successful authorization;
(e) Software-supported creation of an invoice as file amounting the royalty, and automatic transmission to the “contract author” by e-mail;
(f) Bank transfer of the royalty, held in trust by the “contract service provider”, to the “contract author” by the “contract service provider”.

9. A method of claim 7 wherein the contract service is implemented for cross-border transactions, comprising offering the contract service by the use of a central service in one country and using the contract service by users of different countries.

10. A method of claim 8 wherein the contract service is implemented for cross-border transactions, comprising offering the contract service by the use of a central service in one country and using the contract service by users of different countries.

11. A method of claim 10, further comprising:
(a) Software-supported dialog between “host” and “guest” on the internet (“conference”);
(b) Software-supported electronic signing of the model contract by “host” and “guest” using a certified electronic signature;
(c) Software-supported storing of the signed contract on the contract service provider's server;
(d) Software-supported access to the stored contract via the contract service application.

12. A method for “contract authors” of creating interactive model contracts online by using computerized support, provides by the “contract service provider”, and of holding them ready on the internet (through the World Wide Web), comprising:
(a) Software-supported input of personal data referring to the contraction parties;
(b) Software-supported input of several articles of the model contract as a text;
(c) Software-supported input of the use fee amount;
(d) Saving the so created model contract in a database and holding it ready for demand on the internet.

13. A method of claim 12, further comprising:
(a) Software-supported search for a model contracts according to contract category and keywords;
(b) Software-supported selection of a model contract;
(c) Software-supported input of the contracting parties' personal data to the model contract;
(d) Generating a computer print-out of the so created contract.

14. A method of claim 13, further comprising:
(a) Software-supported input of the user's credit card account information;
(b) Software-supported check-up of the credit card authorization by the provider of the contract service;
(c) Debit entry amounting to the user fee in favor of the “contract author” as-well as a flat fee in favor of the “contract service provider”, account of the user's credit card account after successful authorization;
(d) Software-supported release of the created model contract for printing out;
(e) Software-supported creation of an invoice as file amounting the user fee, and automatic transmission to the “contract author” by e-mail;
(f) Bank transfer of the user fee, held in trust by the “contract service provider”, to the “contract author” by the “contract service provider”.

15. A method of claim 14, further comprising:
(a) Software-supported invitation to a dialog partner (“guest”), who can be chosen freely by the user of the model contract (“host”) by putting the guest's name, his e-mail address as well as a time proposal into the internet application (“invitation”), to hold an interactive “conference”;
(b) Software-supported transmission of the “invitation” to the “guest” via e-mail;
(c) Software-supported dialog between “host” and “guest” on the internet (“conference”), when both log in to the application (“conference room”);
(d) The “host's” software-supported choice during the dialog to determine at any time, whether the “host” or the “guest” is in power to carry out modifications of and amendments to the model contract, which then are apparent on the computer screen immediately;
(e) Generating a computer print-out of the modified or amended contract.

16. A method of claim 15 wherein the dialog is to proceed in writing within a software-supported internet chat-room (“chat”).

17. A method of claim 15 wherein the dialog is to proceed verbally by telephone (including internet telephony—VoIP).

18. A method of claim 16, further comprising:
(a) Software-supported, input of a flat amount of royalty for a certain number of answers by the “guest”, whereas an extension of the conference by the same certain number for the same royalty can be agreed;
(b) Software-supported input of the user's credit card account information;
(c) Software-supported check-up of the credit card authorization by the provider of the contract service;
(d) Debit entry amounting to the royalty in favor of the “contract author” as well as flat fee in favor of the “contract service provider”, account of the user's credit card account after successful authorization;
(e) Software-supported creation of an invoice as file amounting the royalty, and automatic transmission to the “contract author” by e-mail;
(f) Bank transfer of the royalty, held in trust by the “contract service provider”, to the “contract author” by the “contract service provider”.

19. A method of claim 17, further comprising:
(a) Software-supported input of an amount of royalty per minute;
(b) Software-supported input of the user's credit card account information;
(c) Software-supported check-up of the credit card authorization by the provider of the contract service;
(d) Debit entry amounting to the royalty in favor of the “contract author” as well as a flat fee in favor of the “contract service provider”, account of the user's credit card account after successful authorization;
(e) Software-supported creation of an invoice as file amounting the royalty, and automatic transmission to the “contract author” by e-mail;
(f) Bank transfer of the royalty, held in trust by the “contract service provider”, to the “contract author” by the “contract service provider”.

20. A method of claim 18 wherein the contract service is implemented for cross-border transactions, comprising offering the contract service by the use of a central service-in one country and using the contract service by users of different countries.

21. A method of claim 19 wherein the contract service is implemented for cross-border transactions, comprising offering the contract service by the use of a central service in one country and using the contract service by users of different countries.

22. A method of claim 21, further comprising:
(a) Software-supported dialog between “host” and “guest” on the internet (“conference”);
(b) Software-supported electronic signing of the model contract by “host” and “guest” using a certified electronic signature;
(c) Software-supported storing of the signed contract on the contract service provider's server;
(d) Software-supported access to the stored contract via the contract service application.
